(19) United States
(12) Patent Application Publication
(10) Pub. No.: US 2022/0118392 A1
(43) Pub. Date: Apr. 21, 2022

(54) TOWER TYPE AIR CLEANING DEVICE FOR OUTDOOR

(71) Applicant: Taeho YOON, Seoul (KR)

(72) Inventor: Taeho YOON, Seoul (KR)

(21) Appl. No.: 17/603,000

(22) PCT Filed: Apr. 1, 2020
(86) PCT No.: PCT/KR2020/004475

§ 371 Date: Oct. 11, 2021

(30) Foreign Application Priority Data
Apr. 10, 2019 (KR) 10-2019-0042088

(51) Int. Cl. B01D 46/44; B01D 46/12; B01D 46/62; B01D 46/42; A61H 33/06; F24F 11/00; F24F 8/10; F24F 13/10; F24D 11/00; F24D 19/10

(52) U.S. Cl. CPC B01D 46/44; F24F 2130/10; B01D 46/62; B01D 46/4245; A61H 33/063; A61H 33/066; F24F 11/0001; F24F 8/10; F24F 13/10; F24D 11/003; F24D 19/1009; B01D 2279/40; B01D 2279/35; A61H 2201/0242; A61H 2201/0214; A61H 2201/0207; F24F 2011/0002; B01D 46/12

(57) ABSTRACT

Provided is a tower-type outdoor air cleaning apparatus that is disposed outside a facility that performs air cleaning, cleans outside air, and supplies the cleaned air, including: a tower body unit that is disposed away from the facility on one side of the facility, is provided in a tower type with a double-wall structure, in which fomentation is performed inward, air is filtered and suctioned, and is exhausted; an air supply unit that is provided above the tower body unit, in which air is supplied through an upper portion thereof and air flows in through a side portion at a plurality of locations of an outer circumference thereof and is mixed with the air supplied through the upper portion; an air ventilation filter unit that is disposed inside the air supply unit and the tower body unit, filters the mixed air supplied from the air supply unit to be supplied to the facility connected thereto, and exhausts the air circulated in the facility to the outside; a fomentation facility unit that is disposed inside the tower body unit and generates heat and electricity using solar energy for use in fomentation; and a control unit that is connected to the air ventilation filter unit and the fomentation facility unit to control the amount of air supplied by the air supply unit through the air ventilation filter unit, and controls production and transfer of heat and electricity using solar energy in the fomentation facility unit.

### TECHNICAL FIELD

The present disclosure relates to a tower-type outdoor air cleaning apparatus, and more particularly to, a tower-type outdoor air cleaning apparatus that cleans indoor air having an improved structure such that air having different flow directions in accordance with the seasonal divisions flows in from the outside and is filtered for supply and the indoor air is exhausted to the outside to thereby improve air cleaning efficiency.

### BACKGROUND ART

In general, an air cleaning apparatus is an apparatus that filters polluted indoor air for cleaning, and is provided to suction the polluted air and to filter the suctioned polluted air using a filter.

The air cleaning apparatus is classified into an outdoor-type air cleaning apparatus that cleans air flowed from the outside and supplies the cleaned air and an indoor-type air cleaning apparatus that is disposed indoors and cleans indoor air while the indoor air is being circulated.

In recent years, since the degree of air pollution of outdoor air increases due to increase of fine dust and air pollution, the indoor-type air cleaning apparatus has been widely used, instead of the outdoor-type air cleaning apparatus.

However, in the indoor air cleaning apparatus, since the air cleaning is performed while indoor air is being circulated, the quality of the circulating indoor air gradually decreases after a certain period of time. Thus, ventilation for exchange of the indoor air with outdoor air becomes necessary, and thus, in a case where polluted outdoor air flows in, the polluted air remains before the cleaning.

In this regard, in recent years, a technique that performs continuously cleaning using a structure in which an air cleaning apparatus is disposed at a part of an air ventilation facility where outdoor air flows in to clean the outdoor air at the part where the outdoor air flows in has been proposed.

However, such an air cleaning apparatus in the related art is connected to an air ventilation facility in a state of being located outside, and is merely able to remove impurities from the air.

In this consideration, it is desirable to provide an air cleaning apparatus capable of continuously supplying clean air containing energies in winds of different directions in accordance with climatic characteristics of 24 seasonal divisions to improve air cleaning efficiency.

### DISCLOSURE

### Technical Problem

In order to solve the above-described problems, there is provided a tower-type outdoor air cleaning apparatus that is disposed outdoors in a tower form and has such a configuration that supply directions are controlled in accordance with wind directions based on 24 seasonal divisions and indoor air is cleaned in a state of being mixed with outside air to be supplied to the inside, to thereby maximize air cleaning efficiency.

The present inventive concept is not limited to the above-mentioned objects, and other objects which are not mentioned will be clearly understood from the following description.

### Technical Solution

According to an aspect of the present inventive concept, there is provided a tower-type outdoor air cleaning apparatus that is disposed outside a facility that performs air cleaning, cleans outside air, and supplies the cleaned air, including: a tower body unit that is disposed away from the facility on one side of the facility, is provided in a tower type with a double-wall structure, in which a fomentation facility unit is disposed inward, air is filtered and suctioned, and is exhausted; an air supply unit that is provided above the tower body unit, in which air is supplied through an upper portion thereof and air flows in through a side portion at a plurality of locations of an outer circumference thereof and is mixed with the air supplied through the upper portion; an air ventilation filter unit that is disposed inside the air supply unit and the tower body unit, filters the mixed air supplied from the air supply unit to be supplied to the facility connected thereto, and exhausts the air circulated in the facility to the outside; and a control unit that is connected to the air ventilation filter unit and the fomentation facility unit, and controls the amount of air supplied from the air supply unit through the air ventilation filter unit.

Further, the tower body unit may include a tower body that is disposed away from the facility on one side of the facility and is provided with the air ventilation filter unit and the fomentation facility unit therein, and an inner tower wall that is provided inside the tower body to form a double-wall structure with a space being formed therebetween, and has a circulation space where the air ventilation filter unit is disposed between the tower body and the inner tower wall.

Further, the inner tower wall may be formed in a wall type in which ochre, germanium, and coconut byproducts are mixed.

In addition, the air supply unit may include an air inlet body of a cylindrical shape that is disposed above the tower body unit, has an air inlet port that is formed at a plurality of radial locations of an outer circumference thereof and is opened/closed by an operation of the air ventilation filter unit under the control of the control unit, and has therein an air inlet space where air flowed through the air inlet port and the air supplied through the air inlet port are mixed, and an air supply body that is disposed above the air inlet body, has an air supply port that is formed to supply outside air at a plurality of locations of an outer circumference thereof, and has an air supply space that supplies the air supplied through the air supply port to be mixed with the air in the air inlet space connected to a lower portion thereof by an operation of the air ventilation filter unit under the control of the control unit.

Further, the air inlet ports that are formed at the plurality of radial locations of the outer circumstance of the air inlet body may be formed in 24 directions in accordance with wind directions of the 24 seasonal divisions based on changes of seasonal divisions, and may be opened or closed by the operation of the air ventilation filter unit under the control of the control unit, so that air flows in therethrough.

Further, the air ventilation filter unit may include a supply opening/closing part that is disposed between a location of the air supply unit where air is supplied and a location of the air supply unit where the air is mixed, and is operated to allow or block the supply of the supplied air to the mixing location under the control of the control unit, an inlet opening/closing part that is disposed in each of the air inlet ports formed at the plurality of locations of the outer circumstance of the air supply unit, and is operated to be opened or closed under the control of the control unit according to the seasonal divisions to control an air flow direction, a first filter that is disposed inside the tower body unit, and primarily filters impurities in a location to which the mixed and supplied air through the air supply unit is supplied at an outer circumstance of the double-wall structure of the tower body unit, a second filter that is disposed under the first filter, and secondly filters impurities of the air passed through the first filter, a suction pipe that is disposed under the second filter, and is connected to the facility from the inside of the tower body unit to supply the secondly-filtered air to the facility, and an exhaust pipe that is disposed inside the tower body unit, and is connected to the facility to exhaust polluted air used in the facility to the outside through the tower body unit.

Further, the control unit may include a main control part that is disposed inside the tower body unit, generates a supply signal for controlling opening/closing of a part of the air ventilation filter unit where air is supplied in consideration of an air volume, and generates an inlet signal for controlling opening/closing of a part of the air ventilation filter unit where air flows in accordance with the seasonal divisions, a supply opening/closing control part that connects the part of the air ventilation filter unit where air is supplied and the main control part, and controls the opening/closing of the part of the air ventilation filter unit where air is supplied, according to the generated supply signal, and an inlet opening/closing control part that connects the part of the air ventilation filter unit where air flows in and the main control part, and controls opening/closing of the part of the air ventilation filter where the air flows in, which is provided at the plurality of radial locations and is opened in accordance with the seasonal divisions according to the generated inlet signal.

Further, the tower-type outdoor air cleaning apparatus may further include a fomentation facility unit that is disposed inside the tower body unit, and generates heat and electricity using solar energy for use in fomentation.

Here, the fomentation facility unit may include a fomentation room including at least one panel-type solar panel that is disposed at the outer circumstance of the tower body unit, and absorbs solar light to generate heat, a boiler pipe that is disposed between the solar panel and the tower body unit, is connected to a location where the fomentation facility unit is provided in a state of being wound around in the solar panel in plural turns, and heats water circulated therein by transfer of heat generated in the solar panel, a boiler part that is disposed in an inner portion partitioned by a double wall of the tower body unit, and supplies water at a predetermined temperature under the control of the control unit using hot water supplied through the boiler pipe to the inside, a cold water supply tank that is connected to the boiler pipe, and stores cold water to be heated by the solar power generation panel and cold water to be used in the boiler part, a hot water storage tank that is connected to the boiler part, and stores hot water supplied through the boiler pipe, at least one solar power generation panel that is disposed around the outer circumstance of the tower body unit and is provided in a panel form in which solar light is absorbed to generate power, a power storage battery that is connected to the solar power generation panel, and stores power generated in the solar power generation panel, and a floor body that is disposed on the bottom of the inner portion partitioned by the tower body unit, and is provided so that water heated by the boiler part connected thereto is circulated to dissipate heat.

Further, a fomentation space where the fomentation facility unit is disposed may be provided in the inner portion partitioned by the double wall of the tower body unit. The tower-type outdoor air cleaning apparatus may further include a boiler control part that connects the boiler part of the fomentation facility unit and the main control part, and controls the temperature of the boiler part of the fomentation facility unit according to the boiler control signal. The control unit may generate a boiler control signal for controlling the temperature of the boiler part to which the water heated by the heat generated by solar heat is supplied and transmits the generated boiler signal to the boiler control part to control the temperature at which the floor body is heated.

The specific details for achieving the above objects will be clarified with reference to the following detailed embodiments and the accompanying drawings.

However, the present inventive concept is not limited to the following embodiments, and may have different various modifications, and is provided to completely inform those skilled in the art of the technical concept of the invention.

### Advantageous Effects

According to the above-described aspect of the present inventive concept, it is possible to provide an outdoor-type air cleaning apparatus that is disposed outdoors in a tower form and has such a configuration that supply directions are controlled in accordance with wind directions based on 24 seasonal divisions and indoor air is cleaned in a state of being mixed with outside air to be supplied to the inside, to thereby maximize air cleaning efficiency.

Further, according to the aspect of the present inventive concept, it is possible to provide an outdoor-type air cleaning apparatus capable of providing a fomentation room where clean air is supplied to the inside of a tower, heating is performed by using solar energy, and far-infrared radiation is emitted from elvan stone and coconut powder.

### BRIEF DESCRIPTION OF THE DRAWINGS

FIG. 1 is a perspective view showing a tower-type outdoor air cleaning apparatus according to an embodiment of the present inventive concept.

FIG. 2 is a front view of the tower-type outdoor air cleaning apparatus in FIG. 1.

FIG. 3 is a sectional view showing interior of the tower-type outdoor air cleaning apparatus in FIG. 1.

FIG. 4 is a use state diagram showing a state in which air is cleaned to be suctioned to a facility in the tower-type outdoor air cleaning apparatus in FIG. 1.

FIG. 5 is a use state diagram showing a state in which air is exhausted from the facility in the tower-type outdoor air cleaning apparatus in FIG. 1.

FIG. 6 is an operation state diagram showing a state in which a control unit which is a main component of the tower-type outdoor air cleaning apparatus in FIG. 1 is operated.

### DESCRIPTION OF REFERENCE NUMERALS OF IMPORTANT COMPONENTS IN THE DRAWINGS

100: Air cleaning apparatus, 110: Tower body unit

111: Tower body, 112: Inner tower wall

113: Circulation space, 114: Fomentation space

120: Air supply unit, 121: Air inlet body

122: Air inlet port, 123: Air inlet space

124: Air supply body, 125: Air supply port

126: Air supply space, 130: Air ventilation filter unit

131: Supply opening/closing part, 132: Inlet opening/closing part

133: First filter, 134: Second filter

135: Suction pipe, 136: Exhaust pipe

140: Fomentation facility unit, 141: Solar panel

142: Boiler pipe, 143: Boiler part

144: Cold water supply tank, 145: Hot water storage tank

146: Solar power generation panel, 147: Power storage battery

148: Floor body, 150: Control unit

151: Main control part, 152: Supply opening/closing control part

153: Inlet opening/closing control part, 154: Boiler control part

### BEST MODE

The present inventive concept may have various embodiments and various modification, but specific embodiments will be described hereinafter with reference to the accompanying drawings. However, the present inventive concept is not limited to the specific embodiments, and should be understood to include all changes, equivalents, or substitutions in the scope of the technical concept of the present inventive concept.

In describing the present inventive concept, in a case where a specific description of a related-art technique unnecessarily confuses the point of the present inventive concept, the detailed description will be omitted. In addition, ordinal numerals used in the description (for example, first, second, or the like) are only identifiers for distinguishing one component from another.

Further, in the description, in a case where a specific component is “connected to” another component, it should be understood that the specific component may be directly connected to another component or may be indirectly connected to another component unless a particularly opposed description exists.

Further, a suffix “unit”, or “part” for components used in the description is given for ease of distinction of the components, and does not mean physical separation of the components. In addition, configurations unrelated to the present inventive concept are not shown in the drawings to clearly explain the present inventive concept. The widths, lengths, thicknesses or the like of the components in the drawings may be exaggerated for the convenience of description. Throughout the description, the same reference signs represent the same components.

Hereinafter, specific embodiments of the present inventive concept will be described with reference to the accompanying drawings.

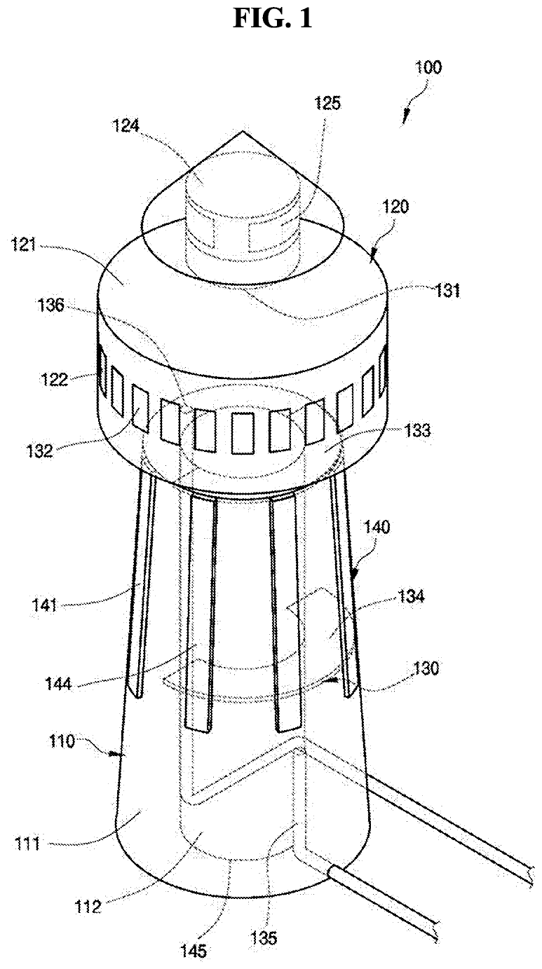

FIG. 1 is a perspective view showing a tower-type outdoor air cleaning apparatus according to an embodiment of the present inventive concept.

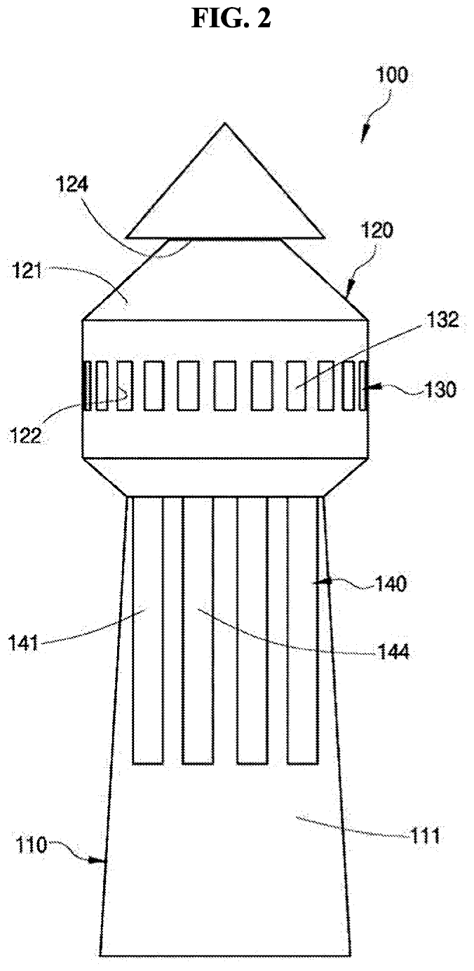

FIG. 2 is a front view of the tower-type outdoor air cleaning apparatus in FIG. 1.

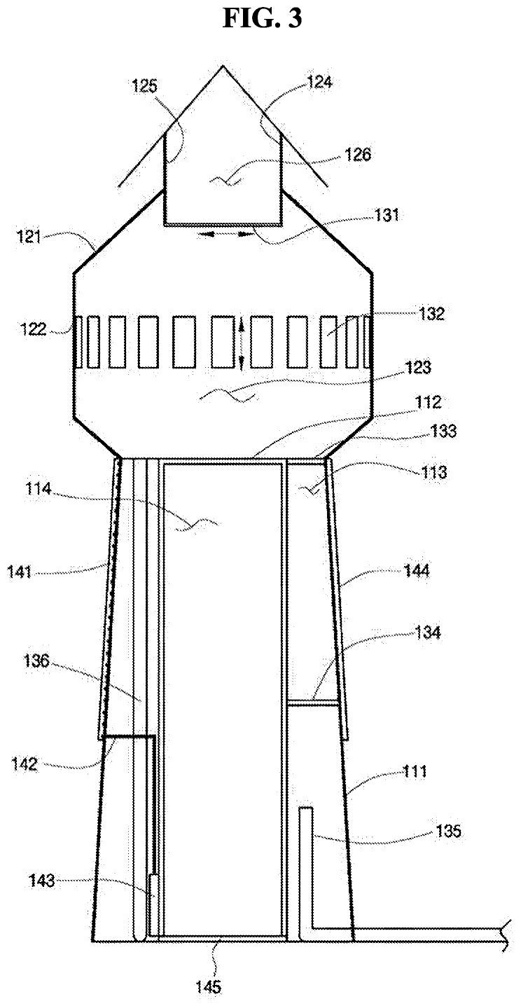

FIG. 3 is a sectional view showing interior of the tower-type outdoor air cleaning apparatus in FIG. 1.

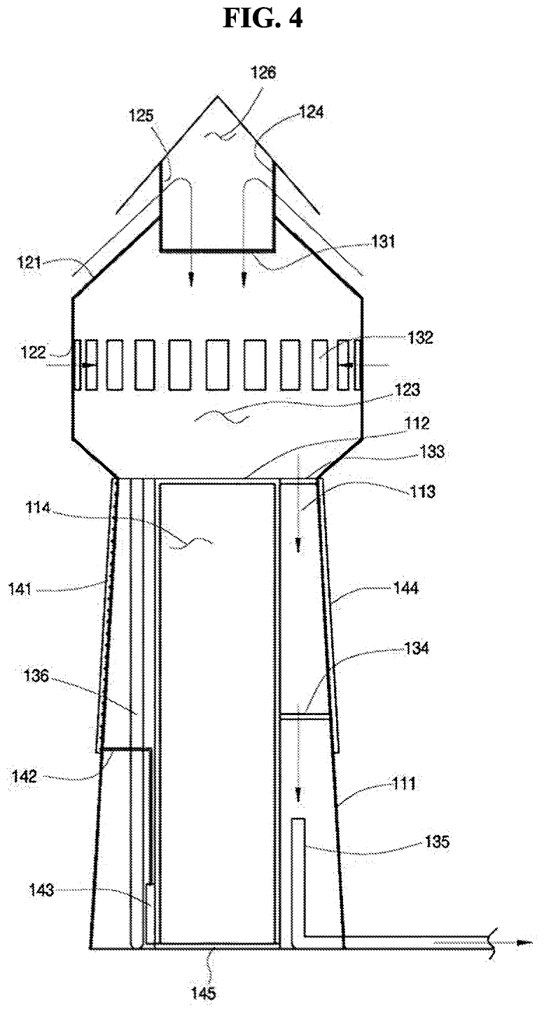

FIG. 4 is a use state diagram showing a state in which air is cleaned to be suctioned to a facility in the tower-type outdoor air cleaning apparatus in FIG. 1.

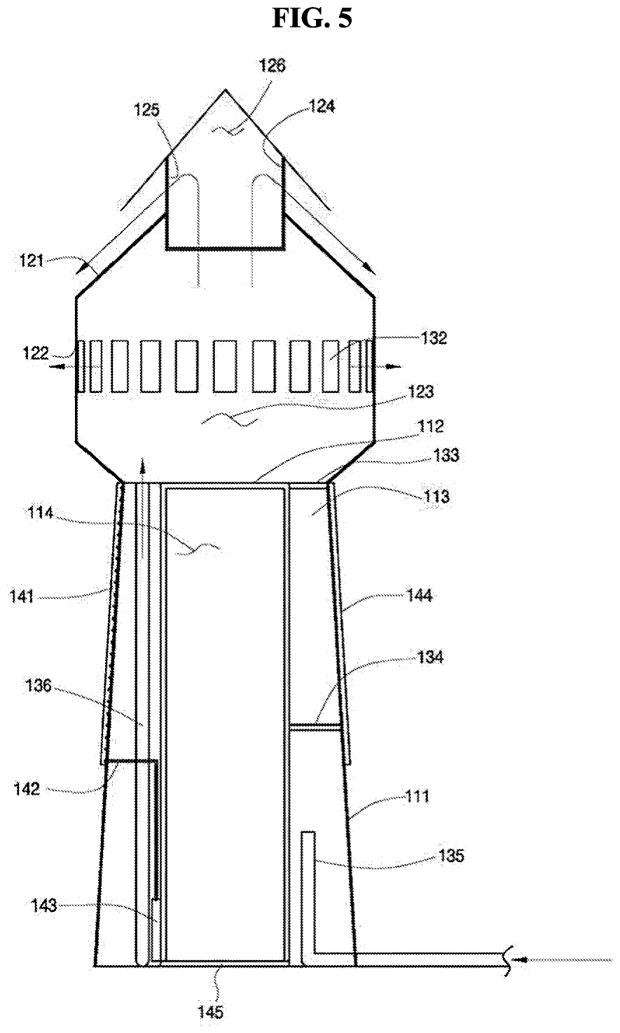

FIG. 5 is a use state diagram showing a state in which air is exhausted from the facility in the tower-type outdoor air cleaning apparatus in FIG. 1.

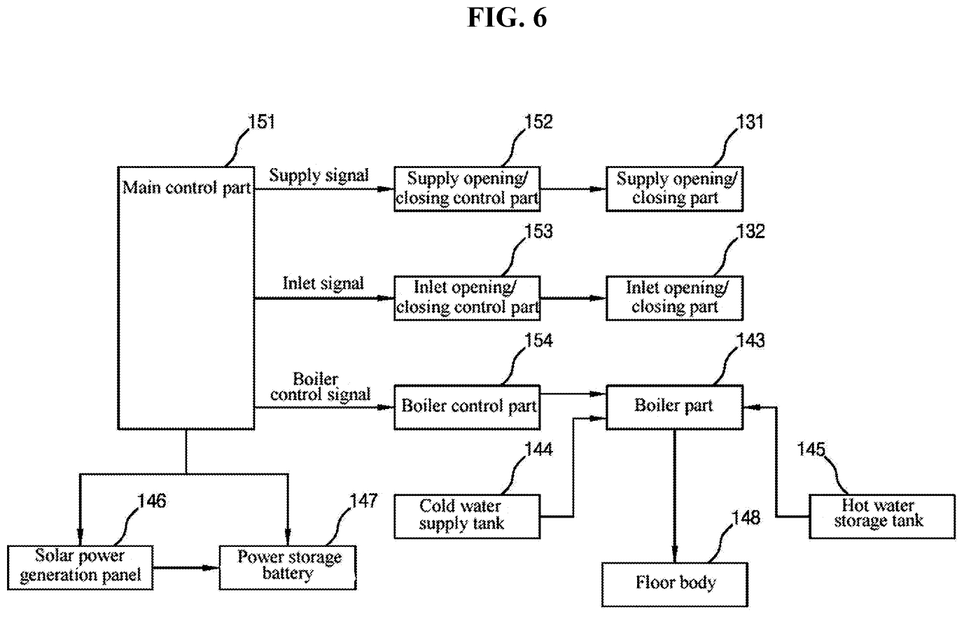

FIG. 6 is an operation state diagram showing a state in which a control unit which is a main component of the tower-type outdoor air cleaning apparatus in FIG. 1 is operated.

Referring to FIGS. 1 to 6, a tower-type outdoor air cleaning apparatus 100 according to an embodiment of the present inventive concept is disposed outside a facility where air cleaning is performed, mixes outside air and air containing energy depending on 24 seasonal divisions in accordance with directions, doubly filters the mixed air, supplies the filtered air to the facility, and also is provided with a fomentation facility using solar heat therein, to thereby improve cleaning efficiency and utilization.

The tower-type outdoor air cleaning apparatus 100 includes a tower body unit 110, an air supply unit 120, an air ventilation filter unit 130, a fomentation facility unit 140, and a control unit 150.

The tower body unit 110 is disposed away from the facility on one side of the facility, and is provided in a tower type with a double-wall structure in which air is filtered and suctioned inwards during fomentation and is exhausted.

The tower body unit 110 includes a tower body 111 and an inner tower wall 112.

The tower body 111 is disposed away from the facility on one side of the facility and is provided with the air ventilation filter unit 130 and the fomentation facility unit 140 therein. The air supply unit 120 into which air is flowed and the air ventilation filter unit 130 that regulates ventilation are disposed at an upper portion of the tower body unit 110.

The inner tower wall 112 is disposed inside the tower body 111 to form a double-wall structure with a space being formed therebetween, and has a circulation space 113 in which the air ventilation filter unit 130 is disposed between the tower body 111 and the inner tower wall 112. A fomentation space 114 where the fomentation facility unit 140 is disposed is provided in the portioned inside. That is, the inner tower wall 112 forms two spaces by doubly dividing an inner space of the tower body 111, in which the air ventilation filter unit 130 is disposed in the outer space and the fomentation facility unit 140 is disposed in the inner space.

The inner tower wall 112 is formed in a wall type in which ochre, germanium, and coconut byproducts are mixed. That, is, the inner tower wall 112 is provided in a wall form in which ochre, germanium, and coconut are mixed in a 7:2:1 ratio, so that active components of far infrared rays and ochre can be emitted to improve the fomentation effect.

The air supply unit 120 is disposed above the tower body unit 110, and is provided so that air is supplied through an upper portion thereof and air flows in through a side portion thereof at a plurality of locations of an outer circumstance thereof and is mixed with the air supplied through an upper portion.

The air supply unit 120 includes an air inlet body 121 and an air supply body 124.

The air inlet body 121 of a cylindrical shape is disposed above the tower body 111, has an air inlet port 122 that is formed at a plurality of radial locations of an outer circumference thereof and is opened/closed by an operation of the air ventilation filter unit 130 under the control of the control unit 150, and has therein an air inlet space 123 where air flowed through the air inlet port 122 and the air supplied through the upper portion are mixed.

The respective flow inlet ports 122 that are formed at the plurality of radial locations of the outer circumstance thereof are formed in 24 directions in accordance with wind directions of the 24 seasonal divisions based on changes of the seasonal divisions, are opened/closed by the operation of the air ventilation filter unit 130 under the control of the control unit 150, so that air flows in therethrough.

In other words, depending on different wind directions of the 24 seasonal divisions, the air inlet ports 122 that are formed in the 24 directions are opened/closed by the operation of the air ventilation filter unit 130 under the control of the control unit 150, respectively, so that outside air flows in through the air inlet ports 122.

The air supply body 124 that is disposed above the air inlet body 121, has an air supply port 125 through which outside air is supplied at a plurality of locations of an outer circumference thereof, and has an air supply space 126 that supplies the air supplied through the air supply port 125 to be mixed with the air in the air inlet space 123 connected to a lower portion thereof by an operation of the air ventilation filter unit 130 under the control of the control unit 150.

That is, the air supplied through the air supply port 125 of the air supply body 124 is supplied to the air supply space 123 from the air supply space 126 by the operation of the air ventilation filter unit 130 under the control of the control unit 150. Thus, in the air flow space 123, air having the flow of energy in accordance with seasonal divisions, flowed through an opened air inlet port 122 among the 24 air inlet ports 122, is mixed with the air supplied from the air supply space 126. As described above, the mixed air is filtered by the air ventilation filter unit 130, and is supplied to the facility.

The air ventilation filter unit 130 is disposed inside the air supply unit 120 and the tower body unit 110, filters the mixed air supplied from the air supply unit 120 to be supplied to the facility connected thereto, and exhausts the air circulated in the facility to the outside.

The ventilation filter unit 130 includes a supply opening/closing part 131, an inlet opening/closing part 132, a first filter 133, a second filter 134, a suction pipe 135, and an exhaust pipe 136.

The supply opening/closing part 131 is disposed between the air inlet body 121 and the air supply body 124 and between the air inlet space 123 and the air supply space 126, and is operated to allow or block the supply of the supplied air to the mixing location under the control of the control unit 150.

That is, the supply opening/closing part 131 is operated according to a control signal of the control unit 150 on the basis of the amount of air to be supplied, and is opened or closed to supply the air in the supply space 126 to the air inlet space 123.

The inlet opening/closing part 132 is disposed in each of the air inlet ports 122 formed at the plurality of locations of the air inlet body 121. The inlet opening/closing part 132 is operated to be opened or closed under the control of the control unit 150 according to seasonal divisions to control the air flow directions.

The first filter 133 is disposed at an upper portion of the circulation space 113 formed by the inner tower wall 112, primarily filters the mixed air in the air inlet space 123 before being supplied to the circulation space 113 to then be supplied to the inside of the circulation space 113.

The second filter 134 is disposed under the first filter 133, and secondly filters impurities of the air passed through the first filter 133.

The suction pipe 135 is disposed under the second filter 134, and is connected to the facility from the inside of the circulation space 113 to supply the secondly-filtered air to the facility.

That, is, the air mixed in the air inlet space 123 is primarily filtered through the first filter 133 disposed at the upper portion of the circulation space 113, and the air primarily filtered by the first filter 133 is secondly filtered by the second filter 134. Then, the secondly filtered air is supplied to the facility through the suction pipe 135, thereby improving the cleaning efficiency.

The exhaust pipe 136 is disposed inside the circulation space 113, and is connected to the facility to exhaust polluted air used in the facility to the outside through the circulation space 113.

The fomentation facility unit 140 is disposed inside the tower body unit 110, and generates heat and electricity using solar energy for use in fomentation.

The fomentation facility unit 140 includes a solar panel 141, a boiler pipe 142, a boiler part 143, a cold water supply tank 144, a hot water storage tank 145, a solar power generation panel 146, a power storage battery 147, and a floor body 148.

At least one solar panel 141 is disposed at the outer circumstance of the tower body 111, and absorbs solar light to generate heat. The solar panel 141 employs a general device that converts solar energy into heat energy, and thus, its detailed description will not be performed.

The boiler pipe 142 is disposed between the solar panel 141 and the tower body 111, is connected to the fomentation space 114 in a state of being wound around in the solar panel 141 in plural turns, and heats water circulated therein by transfer of heat generated in the solar panel 141. That is, the boiler pipe 142 is wound on a heat generation surface of the solar panel 141 in plural turns, and supplies water heated by the heat transferred from the solar panel 141 to the fomentation space 114.

The boiler part 143 is disposed in the fomentation space 114 inside the inner tower wall 112, and supplies water at a predetermined temperature under the control of the control unit 150 using hot water supplied through the boiler pipe 142 to the inside.

The cold water supply tank 144 is connected to the boiler pipe 142, and stores cold water to be heated by the solar panel 141 and cold water to be used in the boiler part 143.

The hot water storage tank 145 is connected to the boiler part 143, and stores hot water supplied through the boiler pipe 142.

At least one solar power generation panel 146 is disposed around the outer circumstance of the tower body 111, and is provided in a panel form in which solar light is absorbed to generate electric power. The solar power generation panel 146 employs a general device that converts solar energy into electric energy, and thus, its detailed description will not be performed.

The power storage battery 147 is connected to the solar power generation panel 146, and stores electric power generated in the solar power generation panel 146.

The floor body 148 is disposed on the bottom of the inner fomentation space 114 partitioned by the inner tower wall 112, and is provided so that water heated by the boiler part 143 connected thereto is circulated to dissipate heat. That is, the floor body 148 has a traditional “ONDOL” structure, and is heated with hot water supplied through the boiler part 143 connected thereto to obtain a fomentation effect.

In addition, a material of the floor body 148 may employ a material used in a traditional dry sauna room, such as elvan or ochre.

The control unit 150 is connected to the air ventilation filter unit 130 and the fomentation facility unit 140 to control the supply of air supplied by the air supply unit 120 through the air ventilation filter unit 130, and controls production and transfer of heat and electricity using solar energy in the fomentation facility unit 140.

The control unit 150 includes a main control part 151, a supply opening/closing control part 152, an inlet opening/closing control part 153, and a boiler control part 154.

The main control part 151 is disposed inside the tower body 111. The main control part 151 transmits a supply signal for controlling the opening/closing of the supply opening/closing part 131 in consideration of an air volume, an inlet signal for selectively controlling the opening/closing of the plurality of inlet opening/closing bodies 132 according to the 24 seasonal divisions, and a boiler control signal for controlling the temperature of the boiler part 143, respectively.

The supply opening/closing control part 152 connects the supply opening/closing part 131 and the main control part 151, and controls the opening/closing of the supply opening/closing part 131 for air supply so that air of the air supply space 126 is mixed into the air inlet space 123 according to the supply signal.

The inlet opening/closing control part 153 connects the inlet opening/closing part 132 and the main control part 151, and controls the opening/closing each of the inlet opening/closing parts 132 that are disposed at the plurality of radial locations and are opened in accordance with the seasonal divisions according to the inlet signal.

The boiler control part 154 connects the boiler part 143 and the main control part 151, and controls the temperature of the boiler part 143 according to the boiler control signal.

That, is, the control unit 150 generates and transmits a supply signal for controlling the opening/closing of the supply opening/closing part 131 for supplying air in the air supply space 126 to the air inlet space 123 in accordance with an air volume necessary for ventilation in the facility to the supply opening/closing part 131 to operate the supply opening/closing part 131 to thereby supply the air to the supply inlet space 123.

In a state where the air is supplied to the air inlet space 123 as described above, in a case where the flow opening/closing parts 132 for opening/closing the respective air inlet ports 122 that are radially disposed at the 24 locations according to supply directions of the air including energies based on the 24 seasonal divisions are selectively opened by transmission of an inlet signal from the main control part 151, the air flows in through the air inlet port 122 and is mixed with the air supplied to the air supply space 126.

The mixed air is primarily and secondarily filtered through the first filter 133 and the second filter 134, and is absorbed in the facility using the suction pipe 135.

Further, the boiler control part 154 is connected to the boiler part 143, and receives, from the main control part 151, a boiler control signal for controlling the boiler part 143 so that hot water supplied through the boiler pipe 142 by heat generated in the solar panel 141 and cold water supplied through the cold water tank 144 are mixed according to a temperature set by a user to be supplied to the floor body part 148 to control the boiler part 143.

The main control part 151 performs controls for supplying electric power for operating the boiler part 143, electric power for operating suction and exhaust pumps for use in the suction pipe 135 and the exhaust pipe 136, and electric power for operating the supply opening/closing part 131 and the inlet opening/closing part 132, using an electrical energy generated by the solar power generation panel 146. Since these control operations are obvious to those skilled in the art, its detailed description will not be performed.

The electric power for operating the boiler part 143, the electric power for operating the suction and exhaust pumps for use in the suction pipe 135 and the exhaust pipe 136, and the electric power for operating the supply opening/closing part 131 and the inlet opening/closing part 132 may be directly supplied from the solar power generation panel 146, or may be indirectly supplied through the power storage battery 147 that charges and stores the electric power generated from the solar power generation panel 146, under the control of the main control part 151.

The above description is made to exemplary embodiments of the technical idea of the present inventive concept, and thus, various modifications and changes may be made within a range without departing from the essential features of the present inventive concept by those skilled in the art.

Accordingly, the embodiments disclosed in the present description are not intended to limit a technical scope of the present inventive concept.

The scope of protection of the present inventive concept must be interpreted by claims, and must be interpreted to include all technical ideas equivalent to the present inventive concept.

1. A tower-type outdoor air cleaning apparatus that is disposed outside a facility that performs air cleaning, cleans outside air, and supplies the cleaned air, comprising:
a tower body unit that is disposed away from the facility on one side of the facility, is provided in a tower type with a double-wall structure, in which a fomentation facility unit is disposed inward, air is filtered and suctioned, and is exhausted;
an air supply unit that is provided above the tower body unit, in which air is supplied through an upper portion thereof and air flows in through a side portion at a plurality of locations of an outer circumference thereof and is mixed with the air supplied through the upper portion;
an air ventilation filter unit that is disposed inside the air supply unit and the tower body unit, filters the mixed air supplied from the air supply unit to be supplied to the facility connected thereto, and exhausts the air circulated in the facility to the outside; and
a control unit that is connected to the air ventilation filter unit and the fomentation facility unit, and controls the amount of air supplied from the air supply unit through the air ventilation filter unit.

2. The tower-type outdoor air cleaning apparatus according to claim 1,
wherein the tower body unit includes
a tower body that is disposed away from the facility on one side of the facility and is provided with the air ventilation filter unit and the fomentation facility unit therein, and
an inner tower wall that is provided inside the tower body to form a double-wall structure with a space being formed therebetween, and has a circulation space where the air ventilation filter unit is disposed between the tower body and the inner tower wall.

3. The tower-type outdoor air cleaning apparatus according to claim 2,
wherein the inner tower wall is formed in a wall type in which ochre, germanium, and coconut byproducts are mixed.

4. The tower-type outdoor air cleaning apparatus according to claim 1,
wherein the air supply unit includes
an air inlet body of a cylindrical shape that is disposed above the tower body unit, has an air inlet port that is formed at a plurality of radial locations of an outer circumference thereof and is opened/closed by an operation of the air ventilation filter unit under the control of the control unit, and has therein an air inlet space where air flowed through the air inlet port and the air supplied through the air inlet port are mixed, and
an air supply body that is disposed above the air inlet body, has an air supply port that is formed to supply outside air at a plurality of locations of an outer circumference thereof, and has an air supply space that supplies the air supplied through the air supply port to be mixed with the air in the air inlet space connected to a lower portion thereof by an operation of the air ventilation filter unit under the control of the control unit.

5. The tower-type outdoor air cleaning apparatus according to claim 4,
wherein the air inlet ports that are formed at the plurality of radial locations of the outer circumstance of the air inlet body are formed in 24 directions in accordance with wind directions of the 24 seasonal divisions based on changes of seasonal divisions, and are opened or closed by the operation of the air ventilation filter unit under the control of the control unit, so that air flows in therethrough.

6. The tower-type outdoor air cleaning apparatus according to claim 1,
wherein the air ventilation filter unit includes
a supply opening/closing part that is disposed between a location of the air supply unit where air is supplied and a location of the air supply unit where the air is mixed, and is operated to allow or block the supply of the supplied air to the mixing location under the control of the control unit,
an inlet opening/closing part that is disposed in each of the air inlet ports formed at the plurality of locations of the outer circumstance of the air supply unit, and is operated to be opened or closed under the control of the control unit according to the seasonal divisions to control an air flow direction,
a first filter that is disposed inside the tower body unit, and primarily filters impurities in a location to which the mixed and supplied air through the air supply unit is supplied at an outer circumstance of the double-wall structure of the tower body unit,
a second filter that is disposed under the first filter, and secondly filters impurities of the air passed through the first filter,
a suction pipe that is disposed under the second filter, and is connected to the facility from the inside of the tower body unit to supply the secondly-filtered air to the facility, and
an exhaust pipe that is disposed inside the tower body unit, and is connected to the facility to exhaust polluted air used in the facility to the outside through the tower body unit.

7. The tower-type outdoor air cleaning apparatus according to claim 1,
wherein the control unit includes
a main control part that is disposed inside the tower body unit, generates a supply signal for controlling opening/closing of a part of the air ventilation filter unit where air is supplied in consideration of an air volume, and generates an inlet signal for controlling opening/closing of a part of the air ventilation filter unit where air flows in accordance with the seasonal divisions,
a supply opening/closing control part that connects the part of the air ventilation filter unit where air is supplied and the main control part, and controls the opening/closing of the part of the air ventilation filter unit where air is supplied according to the generated supply signal, and
an inlet opening/closing control part that connects the part of the air ventilation filter unit where air flows in and the main control part, and controls opening/closing of the part of the air ventilation filter where the air flows in, which is provided at the plurality of radial locations and is opened in accordance with the seasonal divisions, according to the generated inlet signal.

8. The tower-type outdoor air cleaning apparatus according to claim 1, further comprising:
a fomentation facility unit that is disposed inside the tower body unit, and generates heat and electricity using solar energy for use in fomentation.

9. The tower-type outdoor air cleaning apparatus according to claim 1,
wherein the fomentation facility unit includes a fomentation room including
at least one panel-type solar panel that is disposed at the outer circumstance of the tower body unit, and absorbs solar light to generate heat,
a boiler pipe that is disposed between the solar panel and the tower body unit, is connected to a location where the fomentation facility unit is provided in a state of being wound around in the solar panel in plural turns, and heats water circulated therein by transfer of heat generated in the solar panel,
a boiler part that is disposed in an inner portion partitioned by a double wall of the tower body unit, and supplies water at a predetermined temperature under the control of the control unit using hot water supplied through the boiler pipe to the inside,
a cold water supply tank that is connected to the boiler pipe, and stores cold water to be heated by the solar power generation panel and cold water to be used in the boiler part,
a hot water storage tank that is connected to the boiler part, and stores hot water supplied through the boiler pipe,
at least one solar power generation panel that is disposed around the outer circumstance of the tower body unit and is provided in a panel form in which solar light is absorbed to generate power,
a power storage battery that is connected to the solar power generation panel, and stores power generated in the solar power generation panel, and
a floor body that is disposed on the bottom of the inner portion partitioned by the tower body unit, and is provided so that water heated by the boiler part connected thereto is circulated to dissipate heat.

10. The tower-type outdoor air cleaning apparatus according to claim 9,
wherein a fomentation space where the fomentation facility unit is disposed is provided in the inner portion partitioned by the double wall of the tower body unit,
the outdoor air cleaning apparatus further comprising:
a boiler control part that connects the boiler part of the fomentation facility unit and the main control part, and controls the temperature of the boiler part of the fomentation facility unit according to the boiler control signal,
wherein the control unit generates a boiler control signal for controlling the temperature of the boiler part to which the water heated by the heat generated by solar heat is supplied and transmits the generated boiler signal to the boiler control part to control the temperature at which the floor body is heated.
